(19) United States
(12) Patent Application Publication
(10) Pub. No.: US 2020/0408288 A1
(43) Pub. Date: Dec. 31, 2020

(54) HOLLOW NUT DRIVER TOOL

(71) Applicant: AGCO Corporation, Duluth, GA (US)

(72) Inventor: David Wayne O'Reilly, Hesston, KS (US)

(21) Appl. No.: 16/904,323

(22) Filed: Jun. 17, 2020

Related U.S. Application Data
(60) Provisional application No. 62/866,150, filed on Jun. 25, 2019.

(51) Int. Cl. F16H 25/20; B25B 21/00; B25B 13/48

(52) U.S. Cl. CPC F16H 25/20; F16H 2025/209; B25B 13/481; B25B 21/002

(57) ABSTRACT

In one embodiment, an apparatus, comprising: a housing; and plural gears disposed in the housing, wherein at least a first gear of the plural gears comprises a centrally disposed opening configured to mate with a drive tool, wherein a second gear of the plural gears comprises a centrally disposed opening configured to mate with a nut, wherein rotational movement of the first gear causes rotational movement of the second gear.

### CROSS REFERENCE TO RELATED APPLICATION

This application claims the benefit of U.S. Provisional Application No. 62/866,150, filed Jun. 25, 2019, which is hereby incorporated by reference in its entirety.

### TECHNICAL FIELD

The present disclosure is generally related to tools, and, more particularly, tools for use in confined spaces.

### BACKGROUND

It's often said, use the right tools for the job. However, space constraints often pose challenges to the use of standard tools, which segues into another oft-saying—necessity is the mother of invention. In the case of agricultural machines, and in particular, combine harvesters, space constraints may pose challenges to the assembly, maintenance, or repair of one or more of the many belt drives typically used in combine harvesters. For instance, a spring-loaded tensioner is usually employed as the best-cost solution to maintaining proper tension on a belt. A hexagonal (hex) nut is threaded onto a threaded (tension) rod, which is connected to a swing arm and is typically used to compress a helical spring to apply tension to a belt (via movement of the swing arm). The magnitude of spring compression plus the added allowance to permit installation of the belt typically adds up to 150-200 millimeters, which is the distance that the hex nut needs to spin onto the threaded rod (primarily against a spring axial load). Installation and removal of the nut can be slow and laborious. Often, a fabricated tool is used in the form of a very long socket. The extended length of the socket permits the employ of cordless power tools to drive-on and drive-off the hex nut (e.g., for adjustment of tension). However, for some belt drives in combine harvesters (or other machines), the space-claim does not provide enough clearance for the tool and/or the powered drive tool.

### SUMMARY OF THE INVENTION

In one embodiment, an apparatus, comprising: a housing; and plural gears disposed in the housing, wherein at least a first gear of the plural gears comprises a centrally disposed opening configured to mate with a drive tool, wherein a second gear of the plural gears comprises a centrally disposed opening configured to mate with a nut, wherein rotational movement of the first gear causes rotational movement of the second gear.

These and other aspects of the invention will be apparent from and elucidated with reference to the embodiment(s) described hereinafter.

### BRIEF DESCRIPTION OF THE DRAWINGS

Many aspects of a hollow nut driver tool and corresponding system of the present disclosure can be better understood with reference to the following drawings. The components in the drawings are not necessarily to scale, emphasis instead being placed upon clearly illustrating the principles of a hollow nut driver tool and associated system. Moreover, in the drawings, like reference numerals designate corresponding parts throughout the several views.

FIG. 1 is a schematic diagram that illustrates, in fragmentary view, an example environment in which an embodiment of a hollow nut driver tool may be used.

FIG. 2 is a schematic diagram that shows a close-up view of a threaded tension rod with hexagonal nut that can mate with an embodiment of a hollow nut driver tool.

FIG. 3 is a schematic diagram that illustrates an example system that uses an embodiment of a hollow nut driver tool.

FIG. 4 is a schematic diagram that illustrates another view of an embodiment of a hollow nut driver tool interacting with a drive tool.

FIG. 5 is a schematic diagram that illustrates in isometric view, with a top cover hidden, an embodiment of a hollow nut driver tool.

FIG. 6 is a schematic diagram that illustrates, in exploded view, an embodiment of a hollow nut driver tool.

### DESCRIPTION OF EXAMPLE EMBODIMENTS

Certain embodiments of a hollow nut driver tool and system are disclosed that facilitate belt tensioning adjustment for belt drives in machines with challenging space-claims. In one embodiment, the hollow nut driver tool comprises a housing having a handle and a hollow portion, the hollow portion occupied by plural gears that are operatively coupled together such that a drive tool mating with, and causing rotation of, one of the gears causes rotation in another of the plural gears that is connected to a hexagonal (hex) nut of a threaded tension rod.

Digressing briefly, drive tools (powered or otherwise) are often used with a long socket to facilitate the movement of the hexagonal nut along the tension rod. However, for some belt drives of a machine (e.g., a combine harvester), the space-claim does not provide enough clearance for the use of such tools. By using a drive tool in conjunction with an embodiment of a hollow nut driver tool, belt tension adjustment in many of these space-constrained areas may be enabled.

Having summarized various features of certain embodiments of a hollow nut driver tool of the present disclosure, reference will now be made in detail to the detailed description of a hollow nut driver tool as illustrated in the drawings. While the disclosure is described in connection with these drawings, there is no intent to limit it to the embodiment or embodiments disclosed herein. For instance, though emphasis is placed on an environment comprising belt drives in a combine harvester, in some embodiments, the hollow nut driver tool may be used for belt tension adjustment in other machines. Also, certain embodiments of a hollow nut driver tool may be used in other applications, including in construction or industrial applications where there is a need for advancing or retreating a nut along a threaded rod in space-constrained areas (or in some embodiments, non-space-constrained areas). It is noted that the hollow nut driver tool described herein may be used during the assembly process or in the field. Further, although the description identifies or describes specifics of one or more embodiments, such specifics are not necessarily part of every embodiment, nor are all various stated advantages associated with a single embodiment. On the contrary, the intent is to cover all alternatives, modifications and equivalents included within the scope of a hollow nut driver tool as defined by the appended claims. Further, it should be appreciated in the context of the present disclosure that the claims are not necessarily limited to the particular embodiments set out in the description.

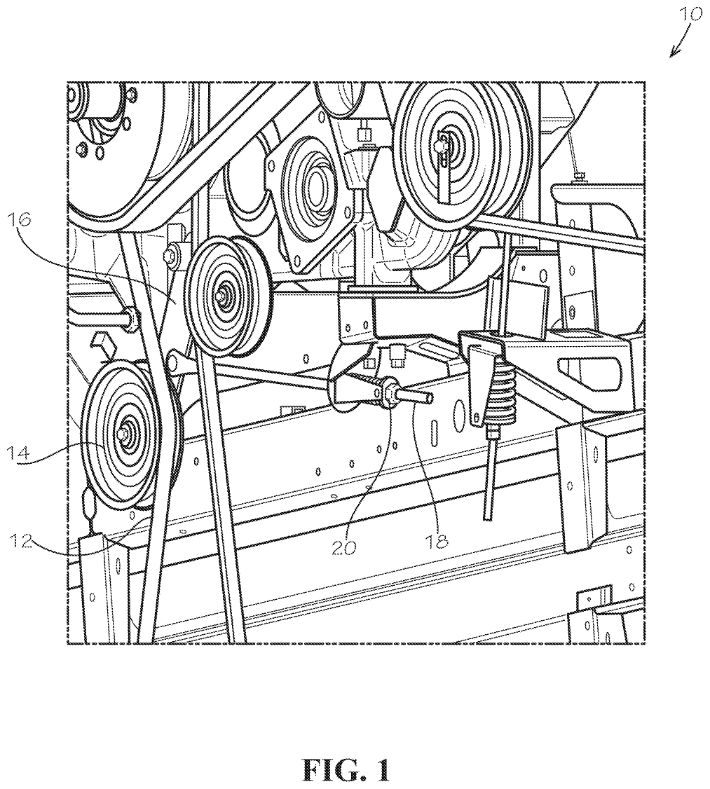

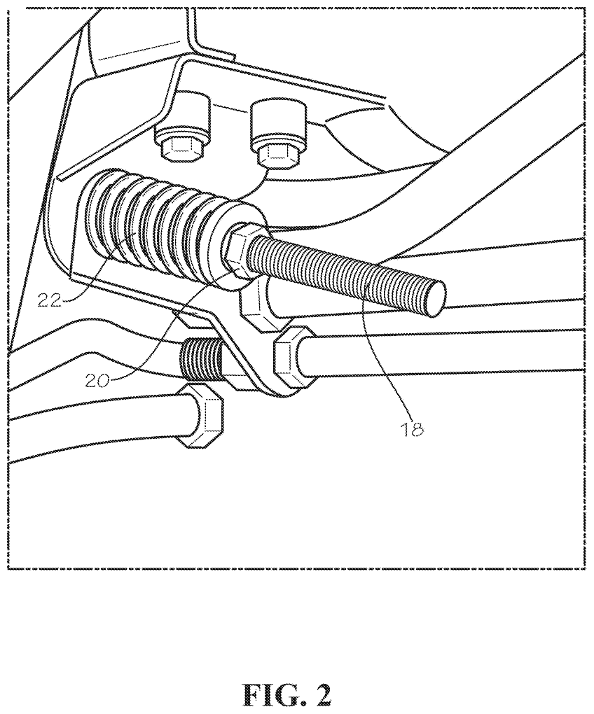

Referring now to FIG. 1, shown is a schematic diagram of an example environment 10 in which an embodiment of a hollow nut driver tool may be used. The example environment 10 comprises a belt drive system that may be used on a combine harvester, where in this example, the belt drive system is arranged on the lower left side of the combine harvester and functions to run a shaker mechanism of the combine harvester. It should be appreciated that this particular belt drive system is illustrative of one example among a plurality of other belt drive systems that typically operate on a combine harvester to implement various functionality, and that is not necessarily representative of a belt drive system that has space-claim issues. Rather, this particular belt drive system is shown to illustrate the components that may interface with an embodiment of a hollow nut driver tool. Further, in some embodiments, an embodiment of a hollow nut driver tool may be used with one or more belt drive systems located on other types of machines, and hence the environment is not limited to use on a combine harvester, or to belt drives or to machines. The belt system comprises one or more endless belts, including belt 12, that are driven and/or guided by a plurality of pulley wheels, including pivoting idler wheel 14. In one embodiment, the belts 12 may be made of an elastomeric material. As is known, the pivoting idler wheel 14 is adjusted in position through its connection to a pivoting swing arm 16, which through that movement, causes a change in the tension of the belt 12. The swing arm 16 in turn is adjusted through the use of a tensioning system (circled in FIG. 1) comprising a spring-loaded, threaded tension rod 18 (also referred to simply as a threaded rod) and hexagonal (hex) nut 20. In conventional systems, a drive tool (not shown), including a power drive tool or unpowered drive tool (e.g., self-ratcheting wrench), mates with the hex nut 20 and, through force exerted by the drive tool (e.g., drilling action or manual torque), the hex nut 20 is advanced or retreated along the threaded rod 18, causing the spring to compress or decompress, which in turn adjusts the position of the swing arm 16. FIG. 2 provides a close-up view of the tensioning system, including the threaded rod 18, the hex nut 20, and a helical spring 22 that is compressed or decompressed through action of the nut (upon the mating with a drive tool and forces associated drive tool action).

In areas where the space-claim provides insufficient clearance for a drive tool, a long socket may be used to mate the drive tool with the hex nut 20. Even so, some belt drives may present space-claim constraints where the long socket cannot be used. Such conditions may be addressed with an embodiment of a hollow nut driver tool, as described further below.

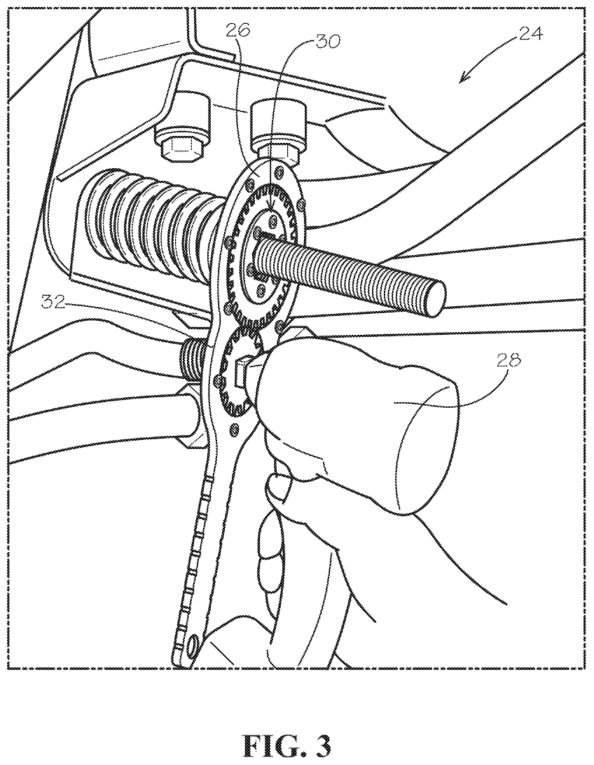

FIG. 3 is a schematic diagram that illustrates an example system 24 that uses an embodiment of a hollow nut driver tool as used with the example environment (equivalently, the belt drive system in this example) 10 (FIG. 1). In particular, the system 24 comprises a hollow nut driver tool 26 and a drive tool 28. In general, given the challenge of space constraints for a given application, the hollow nut driver tool 26 should be comparable in size with the drive tool 28. In this example, the drive tool 28 is depicted as a powered (e.g., electrically powered, pneumatically powered) drive tool 28 (e.g., a powered drill), though in some embodiments, the drive tool 28 may be a ratchet tool that operates under manual (not powered by electrical or pneumatic energy) forces. The hollow nut driver tool 26 operably and physically interfaces with, or equivalently, mates with the hex nut 20 (obscured from view in FIG. 3) at one location 30 of the hollow nut driver tool 26, and further mates with the drive tool 28 at another location 32 of the hollow nut driver tool 26. As explained further below, the hollow nut driver tool 26 comprises plural gears that are disposed within the housing of the hollow nut driver tool 26, wherein at least two of the gears comprises respective central openings that physically mate with a bit or functionally equivalent part of the drive tool 28 and the hex nut 20. For instance, in an embodiment that uses two (2) gears, rotational movement of the bit of the drive tool 28 causes, through its mating of the bit with one of the gears, rotation of that gear, which in turn causes (indirectly, or rather, not via direct coupling) rotation of the gear that mates with the hex nut 20 (via the intermeshing of gear teeth).

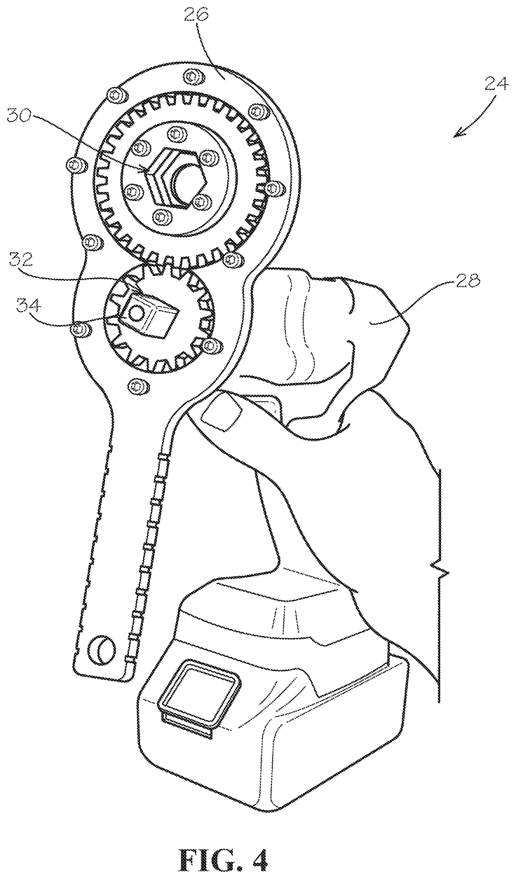

FIG. 4 is a schematic diagram that illustrates another view of the system 24 depicted in FIG. 3. In particular, the system 24 comprises the hollow nut driver tool 26 interfacing with the drive tool 28. The locations 30 and 32 provide a further example illustration of the manner in which the system 24 interfaces with the tensioning system and the manner in which the hollow nut driver tool 26 interfaces with the drive tool 28. At location 30, the hollow nut driver tool 26 comprises a hexagonal (hex) opening that is configured to mate with the hex nut 20 (FIG. 2) of the tensioning system described above. At location 32, shown is a square bit 34 of the drive tool 28. In this embodiment, the location 32 comprises a square opening that is configured to mate with the square bit 34. As is known, driver tool sizes generally include ⅜ inch and ½ inch square. In some implementations, a ¼ inch female hex may be used (e.g., typically for compact impact screw drivers), where adapter bits may be used to convert the output to a ¼ inch, ⅜ inch and ½ inch square driver or ¼ inch male hex. Accordingly, in some embodiments, the opening at location 32 may be of different geometric configuration and/or size (than emphasized in this description and depicted in FIG. 4) that is sufficient to be employed accommodate the different types of drive tool bits used in industry. The hollow nut driver tool 26 has internal gears with respective central openings co-aligned with axes projecting through the respective locations 30 and 32. When the drive tool 28 is activated (to cause rotational movement of the square bit 34), the rotational movement of the square bit 34 causes a corresponding rotation at the gear having the central opening aligned with the location 32. Through the intermeshing of gear teeth of the gears located within the hollow nut driver tool 26, the gear having a central opening co-aligned with an axis running through location 30 is also rotated, which through its mating with the hex nut 20, causes the nut 20 to similarly rotate along the threaded rod 18 (FIG. 2) to adjust the location of the swing arm 16 (and hence adjust the tension of the belt 12). Through this configuration of the hollow nut driver tool 26, where space constraints proximal to the hex nut 20 may provide insufficient clearance for the drive tool 28 (with or without an extended length socket) to properly or easily mate with the hex nut 20, the separation distance of the mating portions (drive tool mating and hex nut mating) may permit sufficient clearance to enable adjustment of the tensioning system.

In some embodiments, two gears may be used, with direct intermeshing of gear teeth during rotation. In some embodiments, gears of a different quantity and/or different gear ratios may be used. Further, though a hex nut 20 and square bit 34 are described, in some embodiments, as explained above, different geometric configurations and/or sizes may be used (and hence, the geometry and/or size of the central openings of the gears corresponding to locations 30, 32 may likewise be different).

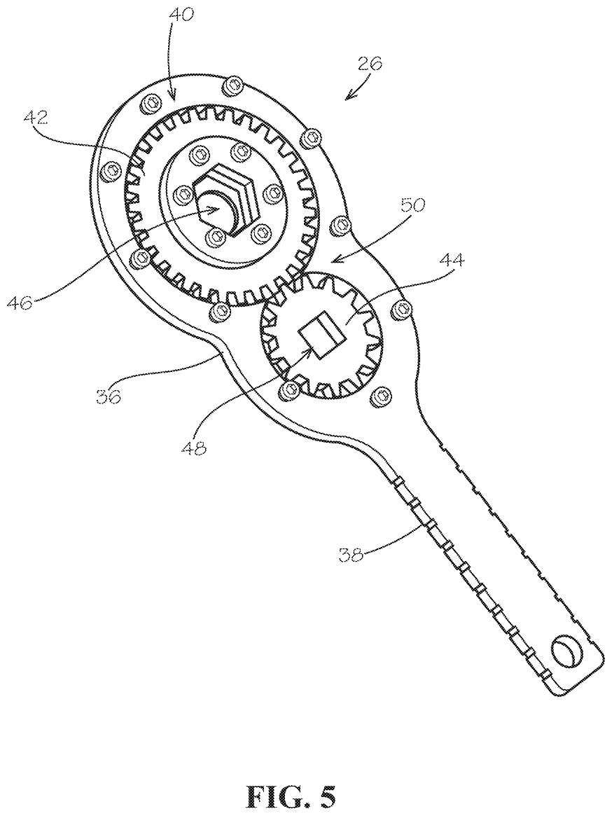

FIG. 5 is a schematic diagram that illustrates in isometric view, with a top cover plate hidden, the hollow nut driver tool 26 that is the same or similar to that depicted in FIG. 4. As shown, the hollow nut driver tool 26 comprises a housing 36 having a traditional guitar-like shape, though in some embodiments, other shape configurations may be used. The housing 36 comprises a handle 38 (e.g., the guitar neck) and a hollow portion 40 (e.g., guitar body), the hollow portion 40 occupied by plural gears. The handle 38 permits a user to apply a leveraged counter force to the reaction torque produced at location 30 (FIG. 4) based on the torque applied by the driver tool 28 at location 32 (FIG. 4). In the embodiment shown in FIG. 5, two (2) gears are depicted, including a hex nut gear 42 (the driven gear) and a drive tool gear 44 (the drive gear) that collectively occupy the hollow portion 40. The hex nut gear 42 and the drive tool gear 44 may be configured as one of a plurality of different types of gears, including spur gears, worm gears, or cross-helical gears. In one embodiment, the hex nut gear 42 comprises a hexagonal (hex) opening 46 co-aligned with an axis running through location 30 (FIG. 4), the hex opening 46 configured to mate with the hex nut 20 (FIG. 2). The drive tool gear 44 comprises a square opening 48 co-aligned with an axis running though location 32 (FIG. 4), the square opening 48 configured to mate with the square bit 34 of the drive tool 28 (FIG. 4). As shown, the hex nut gear 42 comprises plural teeth along the periphery of the gear 42. Similarly, the drive tool gear 44 comprises plural teeth along the periphery of the gear 44. These teeth intermesh at location 50. The center-distance of the hex nut gear 42 and drive tool gear 44 should be sufficient to accommodate the driver tool 28 (FIG. 4). In one embodiment, the center-distance is sixty (60) millimeters, though in some embodiments, depending on the particular application, the center-distance may be different. In one embodiment, the gear ratio (e.g., between the larger hex nut gear 42 and the drive tool gear 44) is within a ratio range of 1:1 to 2:1. In some embodiments, the gear ratio may extend beyond this range (e.g., 10:1, which permits a magnification in torque) depending on the application. For instance, in one embodiment, a gear ratio of 1.67:1 is used, where the application of running the hex nut 20 along the threaded tension rod 18 for the current environment 10 (FIGS. 1 and 2) represents a compromise of speed in favor of torque. However, in some applications, torque may be favored over speed, which may motivate a higher torque ratio. In operation, rotation of the square bit 34 (via the drive tool operation) causes rotation of the drive tool gear 44 via the physical and operative mating of the square bit 34 with the square opening 48. Rotation of the drive tool gear 44 causes rotation of the hex nut gear 42 via the intermeshing of the teeth of both gears 42, 44 at location 50. Rotation of the hex nut gear 42 causes rotation of the hex nut 20 by virtue of the interface (mating) between the hex nut 20 and the hex opening 46. In effect, the drive tool 28 indirectly causes rotation of the hex nut gear 42 (via intermeshing gear teeth) by directly driving (and hence causing) rotation of the drive tool gear 44. In one embodiment, the hex nut gear 42 (e.g., driven gear) is of a larger diameter than the drive tool gear 44 (e.g., pinion gear), as explained above.

As noted above, a different quantity of gears may occupy the hollow portion 40, wherein the rotation of drive tool gear 44 may indirectly (as opposed to directly) cause rotation of the hex nut gear 42 through the intermeshing of the hex nut gear 42 and drive tool gear 44 with one or more intermediate gears.

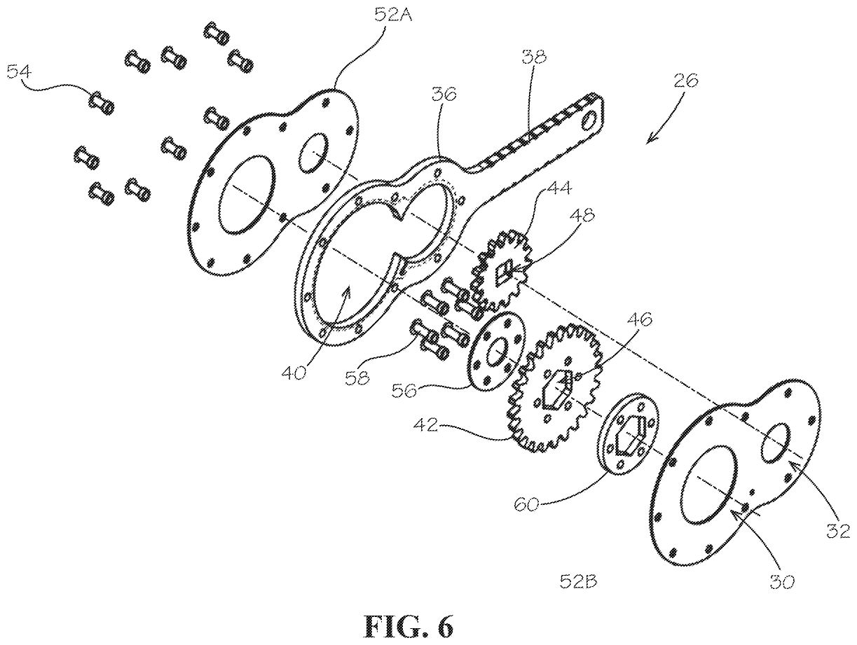

FIG. 6 is a schematic diagram that illustrates, in exploded view, an embodiment of a hollow nut driver tool 26. As described above, the hollow nut driver tool 26 comprises a housing 36 with a handle 38 and a hollow portion 40. The hollow portion 40 is occupied by plural gears, and in the depicted embodiment, two (2) gears comprising hex nut gear 42 and drive tool gear 44. The housing 36 has opposing cover plates securely containing the hex nut gear 42 and drive tool gear 44 within the space of the hollow portion 40, the cover plates including cover plates 52A and 52B. Each of the cover plates 52A, 52B (collectively, cover plates 52) comprise plural (e.g., two) larger openings that are co-aligned with a respective axis corresponding to locations 30, 32. The two openings are sufficiently sized to enable access to, and mating of, the hex opening 46 and the square opening 48 to the hex nut 20 (FIG. 2) and the square bit 34 (FIG. 4), respectively. The cover plates 52 are secured to the housing 36 via a corresponding quantity (e.g., ten (10), though not limited to this quantity) of smaller holes in the housing 36 via securing members 54, which in one embodiment comprises rivets, though in some embodiments other types of securing members (e.g., screws, bolts, etc.) may be used to secure the cover plates 52 to the housing 36. In effect, the hex nut gear 42 and drive tool gear 44 are sandwiched between the cover plates 52.

Secured to one side of the hex nut gear 42 is a hub cap 56 with a central opening (e.g., round opening, though not limited to that geometry) of sufficient size to permit the threaded rod 18 to fit or slide through the opening. The hub cap 56 is secured to the hex nut gear 42 via securing members 58 (e.g., rivets, screws, etc.) disposed through a corresponding quantity of holes (e.g., six (6), though not limited to this quantity) along the periphery of the hub cap 56 and surrounding the hex opening 46. Secured (via the securing members 58) to the opposing side of the hex nut gear 42 is a hub cap 60 (e.g., with a hex opening, though not limited to this geometry) that is dimensioned sufficiently to enable a conformal fit for mating with the hex nut 20, the hub cap 60 likewise comprising smaller holes along the periphery for securement via the securing members 58. In effect, the hex nut gear 42 is secured to, and sandwiched between, the hub caps 56 and 60, and collectively, sandwiched between the cover plates 52 as explained above.

Note that the materials and/or processes used to fabricate the hollow nut driver tool 26 may depend on the expected market distribution, or based on other reasons (e.g., availability and/or cost of resources, expected torque applications, etc.). For instance, in one embodiment, the hollow nut driver tool 26 and associated components may be made of steel, including sheet metal steel that lends itself to laser-based fabrication. For instance, using laser-cut components and a rivet assembly (with no bearings) permits a compact, simple design that is assembled at a relatively low cost. Where the expectation is of mass distribution of the hollow nut driver tool 26, stamped and die-cut sheet metal may be used in the fabrication of the hollow not driver tool 26. In some embodiments, additional or other materials may be used, including aluminum, brass, etc. In some embodiments, the hollow nut driver tool 26 may be fabricated in plastic or a combination of plastic and metal. In some embodiments, the cover plates 52 may be further interfaced to the housing 36 via a sealant (e.g., silicon bead).

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. For instance, in some embodiments, a spring-loaded detent may be used to lock the gear set (e.g., the hex nut gear 42 and drive tool gear 44, FIG. 6) when depressed, enabling the ability to lock the gear set so that the hex nut 20 (FIG. 2) may initially loosened by hand using the hollow nut driver tool 26 (FIG. 6) as a hand wrench before interfacing with the driver tool 28 (FIG. 4) to adjust the hex nut 20 along the threaded tension rod 18 (FIG. 2). Alternatively, the hex nut 20 may be re-tightened. Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality. Any reference signs in the claims should be not construed as limiting the scope.

At least the following is claimed:

1. An apparatus, comprising:
a housing; and
plural gears disposed in the housing, wherein at least a first gear of the plural gears comprises a centrally disposed opening configured to mate with a drive tool, wherein a second gear of the plural gears comprises a centrally disposed opening configured to mate with a nut, wherein rotational movement of the first gear causes rotational movement of the second gear.

2. The apparatus of claim 1, wherein the centrally disposed opening of the first gear comprises a hexagonal opening or a square opening.

3. The apparatus of claim 1, wherein the centrally disposed opening of the second gear comprises a hexagonal opening.

4. The apparatus of claim 1, wherein the plural gears comprise spur gears.

5. The apparatus of claim 1, wherein the plural gears comprise worm gears.

6. The apparatus of claim 1, wherein the plural gears comprise cross-helical gears.

7. The apparatus of claim 1, wherein the first gear and the second gear are coupled directly together.

8. The apparatus of claim 1, wherein the first gear and second gear are operably coupled together via one or more intermediate gears.

9. The apparatus of claim 1, wherein the housing comprises a handle and a hollow portion, the hollow portion occupied by the plural gears.

10. The apparatus of claim 9, wherein the housing comprises a guitar shape.

11. The apparatus of claim 9, wherein the housing comprises opposing cover plates secured to the housing and overlapping the hollow portion, the plural gears sandwiched between the opposing cover plates.

12. A system, comprising:
a drive tool; and
a hollow nut driver tool, the hollow nut driver tool comprising:
a housing; and
plural gears disposed in the housing, wherein at least a first gear of the plural gears comprises a centrally disposed opening configured to mate with the drive tool, wherein a second gear of the plural gears comprises a centrally disposed opening configured to mate with a nut, the first and second gears operably coupled, wherein the drive tool is configured to indirectly cause rotational movement of the second gear by directly driving the first gear.

13. The system of claim 12, wherein the centrally disposed opening of the first gear comprises a hexagonal opening or a square opening.

14. The system of claim 12, wherein the centrally disposed opening of the second gear comprises a hexagonal opening.

15. The system of claim 12, wherein the plural gears comprise spur gears.

16. The system of claim 12, wherein the plural gears comprise worm gears.

17. The system of claim 12, wherein the plural gears comprise cross-helical gears.

18. The system of claim 12, wherein the first gear and the second gear are coupled directly together.

19. The system of claim 12, wherein the first gear and second gear are operably coupled together via one or more intermediate gears.

20. The system of claim 12, wherein the housing comprises:
a handle and a hollow portion, the hollow portion occupied by the plural gears; and
opposing cover plates secured to the housing and overlapping the hollow portion, the plural gears sandwiched between the opposing cover plates.
